(19) United States
(12) Patent Application Publication
(10) Pub. No.: US 2003/0193686 A1
(43) Pub. Date: Oct. 16, 2003

(54) Serial data conversion

(75) Inventor: Robert Hart Nathan, Atlanta, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/121,511

(22) Filed: Apr. 15, 2002

(51) Int. Cl. G06F 15/00; G06K 1/00; B41F 1/00

(52) U.S. Cl. 358/1.15

(57) ABSTRACT

A method of and apparatus for converting a USB-based print command to a serial-based print command at a printer is described. The apparatus includes a USB-based printer receiving a USB-based print command over a USB connection. The USB-based printer has a serial connection. The USB-based printer converts the USB-based print command to a serial-based print command and transmits it over the serial connection for detection by a line detection unit coupled to the serial connection. Responsive to detecting a serial-based print command, the line detection unit transmits a serial-based print command to a serially coupled serial-based printer. The serial-based printer executes the serial-based print command.

### FIELD OF THE INVENTION

The present invention relates generally to a method of and apparatus for converting serial data from one format to another.

### BACKGROUND ART

It is known in the art to transmit serial data from a computer system to a printer thereby causing the printer to print. For example, as shown in FIG. 1, in retail establishments a register or checkout terminal, such as a terminal 100 at a checkout lane 102 of a retail establishment, has an attached printer 104 for printing a receipt for a customer 106. Typically, printer 104 is attached using a serial line, e.g., an RS-232 connection, data line to terminal 100. In normal use, customer 106 provides an item 108 to a checkout operator 110 who rings up the item 108 at terminal 100 and requests payment from customer 106. Upon receiving payment and providing change, if appropriate, checkout operator 110 manipulates keys on a keyboard 112 attached to terminal 100 causing a receipt 114 to be printed at attached printer 104. In an alternate self-service embodiment, customer 106 interacts directly with a modified version of checkout lane 102 to ring up items and tender payment without needing a checkout operator 110.

More specifically, during the transaction, checkout operator 110 enters information about item 108 to be purchased by customer 106, e.g., by scanning a bar code 118 on item 108 using a bar code scanner 116 to obtain item information or entering pricing, bar code 118 or other information using keyboard 112. As checkout operator 110 enters information, terminal 100 maintains a cumulative total for item 108 to be purchased by customer 106. Terminal 100 may also maintain a list of items including item identifying information, e.g., brand and quantity, and item price to be purchased by customer 106.

Upon completion of the transaction including payment by customer 106, checkout operator 110 causes terminal 100 to transmit printing commands for printing the item list and cumulative total price and any additional fees, e.g., taxes, to the attached printer 104 over the serial line (not shown). Printer 104 receives the transmitted terminal 100 printing commands and prints receipt 114 to be provided to customer 106.

Some checkout terminals include the ability to print promotional receipts, e.g., coupons, rebates, or other discount mechanisms, for future customer use to encourage return shopping. In other instances, the ability to print promotional receipts is used as a reward for current shopper purchases. In either embodiment, a separate promotion receipt printer 120 is used to print the promotional receipt for customer 106.

Promotion receipt printer 120 is connected to checkout terminal 100 by a second serial line (not shown) and receives printing commands directly from the checkout terminal. For example, checkout terminal 100 may detect the scanning by the checkout clerk 110 of a particular item, e.g., a specific brand of frozen pizza, being purchased by the customer 106.

Upon detection of the pizza being scanned at the terminal 100 and subsequent lookup and successful comparison of the item with a list of items predetermined to generate a promotional receipt, the information necessary to print the promotional receipt is transmitted from terminal 100 to the promotion receipt printer 120. The promotion receipt is then printed and provided to the customer. Terminal 100 determines whether and when to print promotional receipts at promotion receipt printer 120. In such a configuration, terminal 100 perform the promotional receipt printing determination and issue print commands to both the receipt printer 104 and the promotion receipt printer 120.

In order to lower the complexity, lessen processing requirements on terminal 100, and avoid licensing issues related to intellectual property surrounding a direct terminal to promotion receipt printer 120 connection configuration, an alternate approach has been previously used. FIG. 2 is a high level block diagram of an alternate prior art configuration 200 connecting terminal 100, receipt printer 104, and promotion receipt printer 120. In configuration 200, promotion receipt printer 120 is connected to a line detection unit 202 via a serial connection 204. Line detection unit 202 is attached to the serial connection between the checkout terminal 100 and receipt printer 104. Line detection unit 202 includes a processing system 206, similar to the controller system 300 described below in connection with FIG. 3, and monitors the transmissions between terminal 100 and receipt printer 104 searching for specific keywords or product identifying information. Upon detection of the information, e.g., print commands to print a particular item on printer 104 such as a specific brand of frozen pizza, the line detection unit 202 formats and transmits the necessary print commands to promotion receipt printer 120 and the promotion receipt is then printed and provided to customer 106.

Line detection unit 202 is known in the art and operates in conjunction with serial printing mechanisms. That is, detection unit 202 detects specific print commands transmitted over a serial line, formats a specific output, e.g., a particular coupon or rebate, and transmits print commands to promotion receipt printer 120 for printing the specific output. In one particular embodiment, detection unit 202 passes through detected print commands directly to promotion receipt printer 120. In another embodiment, detection unit 202 performs a lookup, e.g., in a table stored in memory, to determine the specific output to be printed in accordance with the print command detected.

Recent advances in terminals and printers, and more specifically in protocols used for communicating between terminals and printers, have included the transition to the use of a Universal Serial Bus (USB) protocol in place of serial printing. As a result, installations previously using line detection units to print promotional receipts are unable to do so. One possible solution is to purchase new line detection units capable of acting on transmissions over a USB connection; however, there is an increased cost involved both in terms of development and installation/replacement of existing line detection units and promotion receipt printers. Therefore, there is a need in the art for a method of and apparatus for receiving USB-based print commands transmitted to a printer and converting USB-based print commands to serial-based print commands.

There is another need in the art for enabling the use of existing line detection units and promotion receipt printers.

### DISCLOSURE/SUMMARY OF THE INVENTION

It is therefore an object of the present invention to provide a method and apparatus for receiving USB-based print commands transmitted to a printer and converting them to serial-based print commands at the printer.

Another object of the present invention is to enable the use of existing line detection unit design.

Another object of the present invention is to enable the use of existing promotion receipt printer design.

The above described objects are fulfilled by a method of converting USB-based print commands to serial-based print commands using a printer. The printer receives a USB-based print command and converts the received print command to a serial-based print command for transmission over a serial connection for detection by a line detection unit.

In an apparatus aspect, a USB-based printer receives a USB-based print command over a USB connection and has a first serial connection. The USB-based printer converts the USB-based print command to a serial-based print command and transmits the serial-based print command over the first serial connection. A line detection unit is coupled to the first serial connection of the USB-based printer and detects the converted USB-based print command transmitted as a serial-based print command on the first serial connection. The line detection unit transmits a serial-based print command over a second serial connection to a serial-based printer.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, as previously described, is an illustration of one way the method of the invention can be practiced in a purchasing environment;

FIG. 2, also previously described, is a high level block diagram of a configuration of a prior art promotion receipt printer;

FIG. 3 is a high level block diagram of a controller system for use in conjunction with an embodiment of the present invention;

FIG. 4 is a high level block diagram of a configuration of systems usable with an embodiment of the present invention, and;

FIG. 5 is a high level flow diagram of a process of operation of an embodiment of the present invention.

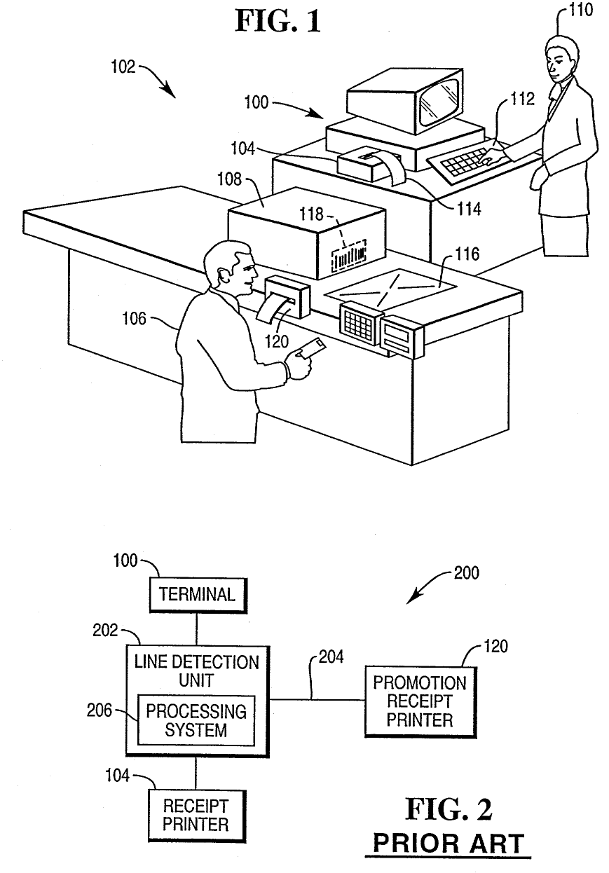

### BEST MODE FOR CARRYING OUT THE INVENTION

A method and apparatus for receiving USB-based print commands and converting the USB-based print commands to serial-based print commands at a printer are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

Top Level Description

An existing USB-based printer is modified to enable the conversion of USB-based printing commands to serial-based print commands. The serial print commands are then transmitted to an existing line detection unit for detection and, when appropriate, generation of print commands to be transmitted to an existing serial promotional receipt printer.

As used herein, the term “serial” refers to the “RS-232 family” of interfaces and USB refers to the standard(s) developed and published by the USBIF (Universal Serial Bus Implementer's Forum), recently incorporated under that name.

### DETAILED DESCRIPTION

A functional description of a controller system found in USB-based printers is provided below.

Functional Controller Description

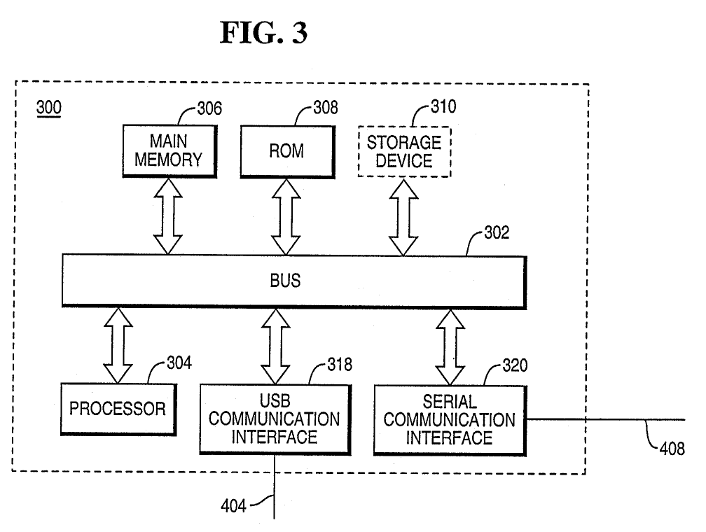

FIG. 3 is a high level block diagram of a controller system 300 for use with an embodiment of the present invention. The present invention is usable with currently available printers.

Controller system 300 includes a bus 302 or other communication mechanism for communicating information, and a processor 304 coupled with the bus 302 for processing information. Controller system 300 also includes a main memory 306, such as a random access memory (RAM) or other dynamic storage device, coupled to the bus 302 for storing received transmissions and instructions to be executed by processor 304. Main memory 306 also may be used for storing temporary variables or other intermediate information during execution of instructions to be executed by processor 304. Controller system 300 further includes a read only memory (ROM) 308 or other static storage device coupled to the bus 302 for storing static information and instructions for the processor 304. An optional storage device 310, such as a magnetic or optical disk, is provided and coupled to the bus 302 for storing transmission data, and instructions.

The invention is related to the use of controller system 300, such as the illustrated system of FIG. 3, to convert USB-based print command transmissions to serial-based print command transmissions. According to one embodiment of the invention, the USB transmissions are converted to serial transmissions by controller system 300 in response to processor 304 executing sequences of instructions contained in main memory 306 in response to input received from USB communication interface 318. Such instructions may be read into main memory 306 from ROM 308 or another computer-readable medium, such as optional storage device 310. The converted transmissions are then transmitted to serial communication interface 320 and subsequently transmitted over a serial connection 408.

However, the computer-readable medium is not limited to devices such as storage device 310. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 306 causes the processor 304 to perform the process steps described below. In alternative embodiments, hard-wired circuitry may be used in place of or in combination with computer software instructions to implement the invention. Thus, embodiments of the invention are not limited to any specific combination of hardware circuitry and software.

USB communication interface 318 couples controller system 300 to a USB connection 404. USB communication interface 318 provides two-way data communication as is known. For example, USB communication interface 318 may be a USB compatible connection or cable to provide a data communication connection to a corresponding type of USB device. As another example, communication interface 318 may be a local area network (LAN) card to provide a data communication connection to a compatible LAN. Wireless links may also be implemented. In any such implementation, communication interface 318 sends and receives electrical, electromagnetic or optical signals which carry digital data streams representing various types of information. Of particular note, the communications through interface 318 may permit transmission or receipt of print commands.

Structural Configuration

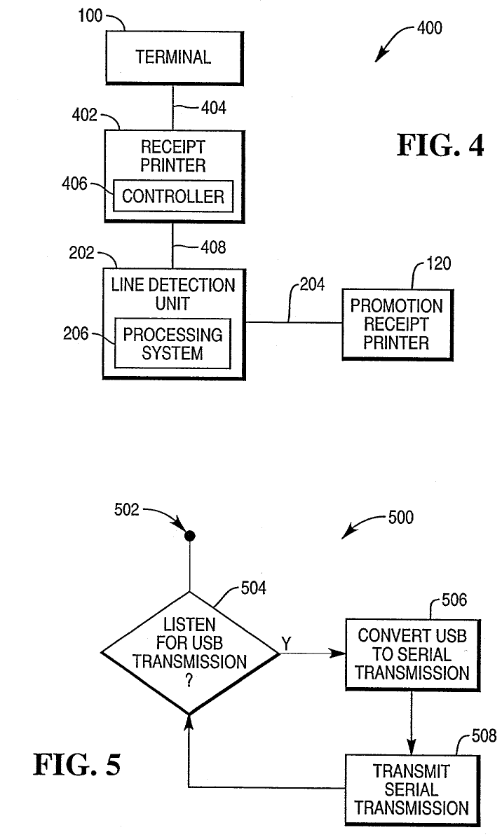

With reference to FIG. 4, a configuration 400 of an embodiment of the present invention is now described. Configuration 400 includes terminal 100, line detection unit 202, and promotion receipt printer 120 previously described in conjunction with configuration 200 of FIG. 2; however, the configuration and operation of terminal, line detection unit, and promotion receipt printer of FIG. 4 are novel.

Terminal 100 is connected to a receipt printer 402 via a USB connection 404. Receipt printer 402 is a USB-based printer and includes a controller system 406, similar to controller system 300 described in detail above. Receipt printer 402, in turn, is connected to existing line detection unit 202 via a serial connection 408. Similar to configuration 200, line detection unit 202 is connected via existing serial line 204 to existing promotion receipt printer 120. Line detection unit 202 and promotion receipt printer 120 operate as has been described above.

Controller system 406 of receipt printer 402 is modified to convert the received USB transmissions from terminal 100 over USB connection 404 to serial transmissions for transmission over serial connection 408. The modification may include the alteration or replacement of instructions for controller system 406 contained in either main memory 306, ROM 308, or optional storage device 310. The serial transmissions are received and operated on by line detection unit 202 as described above. As appropriate, line detection unit 202 transmits specific print commands to promotion receipt printer 120 to cause printing of a promotional receipt. The functional operation of the modified receipt printer 402, and more specifically controller system 406, is now described.

Functional Operation

The operation of the present invention is now described with reference to FIG. 5, wherein an example functional flow diagram of an embodiment of the present invention is shown. The flow of control of an embodiment of the present invention, as indicated by reference numeral 500, begins at step 502. The flow proceeds to step 504 wherein controller system 406 of receipt printer 402 receives transmissions over USB connection 404.

Upon receipt of a specified transmission, the flow of control proceeds to step 506. Controller system 406 performs a look up comparison of the specified transmission with transmissions stored in memory. In step 506, the controller system 406 converts the received transmission to a serial-based format for transmission over serial connection 408. The converted transmissions are the same as the transmissions from terminal 100 to receipt printer 104 in configuration 200. If it is necessary for a complete conversion or generation of the converted transmission, controller system 406 may need to receive additional transmissions from USB connection 404 prior to conversion completion.

As USB transmissions are converted, the flow of control proceeds to step 508 wherein the corresponding serial transmissions are transmitted over serial connection 408. Controller system 406 transmits the serial transmissions in the same manner as terminal 100 of configuration 200 transmitted to receipt printer 104. The flow of control then returns to step 504 to await additional USB transmissions.

Controller system 406 transmits over serial connection 408 without requiring or waiting for responses from a receipt printer.

The above-described configuration 400 allows the continued use of existing line detection units and promotion receipt printers. Advantageously, cost savings are realized because there is no need to replace existing hardware and no need to disturb existing configurations or operations in businesses.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of converting USB-based print commands to serial-based print commands using a printer, the method comprising the following steps:
receiving a USB-based print command at the printer, and;
converting the received print command to a serial-based print command.

2. The method of claim 1, further comprising the step of:
transmitting the serial-based print command along a serial connection for detection by a line detection unit.

3. The method of claim 2 wherein the serial connection couples the printer and the line detection unit.

4. The method of claim 2 further comprising the step of:
transmitting a second serial-based print command from the line detection unit to a second printer.

5. The method of claim 4 wherein the second serial-based print command is the same as the serial-based print command detected by the line detection unit.

6. The method of claim 4 further comprising the step of:
executing the print command at the second printer.

7. The method of claim 4 wherein the second printer is a promotion receipt printer.

8. An apparatus for printing comprising:
an USB-based printer receiving a USB-based print command over a USB connection and having a first serial connection, wherein the USB-based printer converts the USB-based print command to a serial-based print command and transmits the serial-based print command over the first serial connection, and;
a line detection unit coupled to the first serial connection from the USB-based printer to detect the converted USB-based print command transmitted as a serial-based print command on the first serial connection, wherein the line detection unit transmits a serial-based print command over a second serial connection.

9. The apparatus of claim 8 further comprising:
a serial-based printer receiving a serial-based print command over the second serial connection from the line detection unit.

10. The apparatus of claim 4 wherein the serial-based printer is a promotion receipt printer.
